(19) United States
(12) Patent Application Publication
(10) Pub. No.: US 2004/0128511 A1
(43) Pub. Date: Jul. 1, 2004

(54) Methods and systems for generating multimedia signature

(76) Inventors: Qibin Sun, Singapore (SG); Shih-Fu Chang, New York, NY (US); Di Zhong, New York, NY (US); Desai Nayasimhalu, Kent Vale (SG)

Correspondence Address: BAKER & BOTTS, 30 ROCKEFELLER PLAZA, NEW YORK, NY, 10112

(21) Appl. No.: 10/149,685

(22) PCT Filed: Dec. 20, 2000
(86) PCT No.: PCT/US00/34803

(51) Int. Cl. H04L 9/00

(52) U.S. Cl. 713/176; 713/180

(57) ABSTRACT

Techniques for signing multimedia content and verifying received multimedia content that are both robust and accurate are provided. Invariant features are extracted from multimedia content, and certain attributes are computed. Multimedia content is quantized, and extracted invariant features and quantized original multimedia content are encrypted to form a digital signature. The multimedia content and digital signature may be verified even after the introduction of distortions by using content registration. In a preferred embodiment, a refined authentication technique is used to obtain a continuous distance measure, to verify the authenticity of multimedia content based on a pre-defined threshold.

### BACKGROUND OF THE INVENTION

1. Field of the Invention

The present invention relates to techniques for generating an electronic signature for original multimedia content, and for verifying at least a portion of received multimedia content which incorporate electronic signatures.

2. Description of Related Art

In recent years, the use of multimedia applications have become increasingly widespread in connection with electronic business and commerce. In order to ensure the security and integrity of multimedia content, various verification methods have been used, to differing degrees of success. One important issue in contemporary verification methods is how to allow reasonable distortions of the multimedia content during the transmission and storage while simultaneously detecting any malicious manipulations of such content. Typically, the sender provides a digital signature based on the content, or embeds a watermark into the content, so that the recipient can verify the originality of the content which is later received.

Previous work in this area can be classified into three categories based on different requirements for different applications: complete verification, compression-allowed content verification and so-called robust content verification. Generally speaking, the accuracy and the robustness of verification methods are inversely proportional, as shown in FIG. 1. In other words, more accurate verification methods are usually less robust.

One complete verification technique is disclosed in U.S. Pat. No. 5,875,249 (hereinafter “the '249 patent”). The '249 patent proposes a method for invisibly watermarking high-quality color and gray-scale images for authentication purposes, and includes both a watermark stamping process which embeds a watermark in a source image, and a watermark extraction process which extracts a watermark from the stamped source image. The extracted watermark can be used to determine, based on complete verification, whether the source image has been altered. This method can be used for applications such as medical imaging where a change of even one pixel in the received image cannot be allowed.

Another example of a complete verification technique is disclosed U.S. Pat. No. 5,499,294 (hereinafter “the '294 patent”). The '294 patent proposes embedding an encrypted digital signature into a captured image. The scheme is called “trustworthy digital camera,” and is based on Public Key Encryption. The trustworthy digital camera scheme provides a way to protect a source image by verifying the signature to determine whether the image has been forged. If there is even a 1-bit change in the image, the verification fails. While this method allows a determination of whether an image has been altered, it cannot locate any alterations in the image.

U.S. Pat. No. 5,465,299 (hereinafter “the '299 patent”) discloses a technique for generating a digital signature for tracing document changes. In a terminal which receives an electronic document with at least one digital signature, if a user changes the contents of the received electronic document, a new digital signature is produced by using a secret key of the user to encipher new signature data. The signature data includes a hash total of the document of a new version, personal information of the user, and version management information necessary to restore an electronic document of a former version from the electronic document of the new version. The new digital signature and the new version of the electronic document are transmitted together with the received digital signature to another person on a document circulating route. However, the invention is related only to digital contents, namely, binary based data. If the document is printed out, verification will fail.

Examples of compression-allowed content verification techniques are found in the U.S. Pat. Nos. 5,388,158 and 5,742,685 (hereinafter “the '158 patent”and “the '685 patent”, respectively). The '158 and the '685 patents disclose techniques for producing and authenticating a document that is claimed to be secure against tampering or alteration. After a document is scanned, digital signals representing the document are produced, compressed, encrypted and coded by a public-key encryption scheme. The authentication procedure is exactly the inverse procedure of forming the digital signature. However, both techniques are limited in that higher accuracy of document authentication (authentication sensibility) necessarily results in a larger encoded and encrypted file (signature size). If the accuracy requirement is set high so that it can be used to locate forgery, the size of signature will be too large to be practicable. Also, since the final verifications still have to be manually made, the technique is not reliable in detecting small forgeries.

Further examples of compression-allowed verification techniques are disclosed in C. Y. Lin et al., A Robust Image Authentication Method surviving JPEG Lossy Compression, SPIE, (1998) and C. Y. Lin et al., Issues and Solutions for Authenticating MPEG Video, SPIE International Conf. on Security and Watermarking of Multimedia Contents, vol. 3657, EI '99, San Jose USA (1999). In these articles, several techniques to authenticate multimedia content which can prevent malicious manipulations, but allow lossy compression, are described. Authentication signatures are based on the invariance of the relationship between Discrete Cosign Transform coefficients of the same position in separate blocks of an image. This relationship is preserved when these coefficients are quantized in a JPEG compression process. Compression-allowed verification is a practical requirement in storage and transmission. However, it cannot resolve the problems of secure multimedia distribution such as format conversion, scaling and slight distortions.

For example, in some situations, an authorized user can login into a multimedia service center, read and print some secure documents related to its business, and later present the printed documents to support its business. Another authorized viewer can also login into the server to verify the legitimacy of the print-out and check whether the print-out has been altered. In circumstances where a printed copy of an original content is presented for verification, certain distortions may be present in the received content. Some examples of such distortions include scaling, color or intensity changes, slight rotation, or addition of noise. All these distortions may be considered unacceptable in existing verification methods.

Another scenario that is a common procedure in M-commerce (Multimedia commerce) involves a customer wanting to purchase multimedia content from a media distribution center. After a purchase procedure is finished, the authorized customer may have a right to modify the purchased content. For example, if purchased media is music in the MP3 format, and the customer has players which can play MP3, TwinVQ, and WAV, he may need to convert purchased media between formats. From the standpoint of the distribution center, a protection of intellectual property rights is expected. Unfortunately, verification based on the above-discussed techniques cannot provide satisfactory results either because of a lack of robustness or because of unacceptable security risks.

Unlike textual messages, multimedia applications may undergo certain conceptually acceptable manipulations, such as lossy compression, quality enhancement, transcoding, transparent watermarking, printing and rescanning etc. Unfortunately, none of the prior art known hereto provide for verification which can adequately respond to such manipulations. Accordingly, there exists a need for a multimedia signature generation and verification technique that is both robust and very accurate.

### BRIEF SUMMARY OF THE INVENTION

An object of the present invention is to provide a technique for robustly authenticating multimedia content.

Another object of the present invention is to provide a verification technique which permits high verification accuracy of multimedia content.

Yet another object of the present invention is to provide a highly flexible verification technique.

In order to achieve these objectives as well as others that will become apparent with reference to the following specification, the present invention provides techniques for robustly and accurately authenticating multimedia content. In the present invention, robustness is advantageously achieved through a feature-based registration process, an optional error control coding process, and source-optimized vector quantization. Accuracy is achieved by using a typical digital signature scheme and a hierarchical verification procedure. Flexibility is advantageously achieved through scalability of vector quantization.

In one arrangement, invariant features of original multimedia content are extracted. Also, original multimedia content is quantized using vector quantization techniques. Subsequently, the extracted invariant features and quantized original multimedia content are encrypted by a private key to form a digital signature.

In another arrangement, received multimedia content is verified through a feature-based registration process by comparing invariant features that are extracted from the digital signature of original multimedia content with the invariant features extracted from received multimedia signal. If the feature-based registration indicates that received multimedia content is significantly modified, such as when multimedia content has been forged, the authentication fails. If, however, received multimedia content is only slightly modified, and such modifications are acceptable based on a pre-defined threshold, then a refined authentication process is used to determine the integrity of original multimedia content.

In a preferred arrangement, multimedia content is pre-processed to ensure better consistency of results. The invariant features may be extracted manually by inserting one or more landmarks into original multimedia content. Original multimedia content is quantized by one or more codewords, which may be labeled by corresponding index codes. A maximum tolerant authentication error may be defined and one or more codewords may be represented by a codebook.

In yet another arrangement, an error control coding scheme may be used to re-organize the codewords to minimize the weighted distance measure between adjacent codewords. A pseudo-gray code may be assigned to the re-organized one or more codewords. The error control coding scheme may be used to process pseudo-gray codes based on a pre-defined distance threshold and produce a result that may be hashed, to decrease a signature size and to increase security against undetected modifications.

The accompanying drawings, which are incorporated and constitute part of this disclosure, illustrate a preferred embodiment of the invention and serve to explain the principles of the invention.

### BRIEF DESCRIPTION OF THE DRAWING

FIG. 1 is an illustrative diagram of different authentication levels with different robustness and accuracy.

FIG. 2 is an illustrative diagram showing an exemplary application of the present invention.

FIG. 3 is an illustrative diagram showing a second exemplary application of the present invention.

FIG. 4 is a flow diagram showing a process of signing original multimedia content and a process of verifying received multimedia content.

FIG. 5 is a flowchart showing the steps of signing original multimedia content and steps of verifying received multimedia content.

FIG. 6 is a block diagram showing an optional Error Control Coding step in forming a multimedia signature.

FIG. 7(a) is an illustrative diagram of adjacent codewords in a current coding space before Error Control Coding step having centers and disordered indexes.

FIG. 7(b) is an illustrative diagram of adjacent codewords in a current coding space after an Index Assignment and re-coding to Gray Code.

FIG. 7(c) is an illustrative diagram of adjacent codewords in a current coding space and of a new Error Control Coding space where the codewords, that are within a pre-set authentication threshold of an original multimedia input sample (block), are mapped

FIG. 8 is a flow diagram of an invariant feature registration process.

FIG. 9 is an illustrative diagram which shows different quantization regions of an original multimedia content according to their importance.

FIG. 10(a) is an illustrative diagram which shows an original multimedia sample (block) Sₖ that is assigned to a closer codeword C1.

FIG. 10(b) is an illustrative diagram which shows a received multimedia sample (block) Sₖ that is assigned to a closer codeword C2 after some distortion during transmission.

FIGS. 11(a-f) are illustrative diagrams showing verification results of original, forged and time compressed audio signals.

FIGS. 12(a-c) are images of original, printed original, and printed forged Identification Cards.

FIGS. 12(d-h) are illustrative diagrams which show verification results of the printed original and the printed forged images of ID cards.

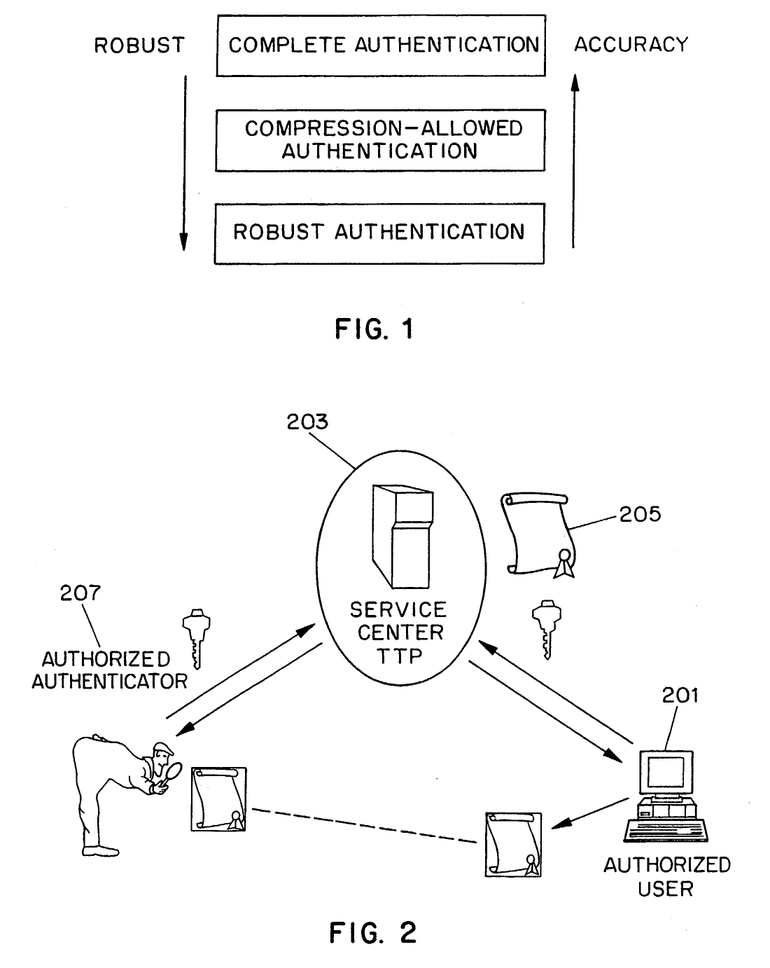

Throughout the figures, the same reference numerals and characters, unless otherwise stated, are used to denote like features, elements, components or portions of the illustrated embodiments.

### DETAILED DESCRIPTION OF PREFERRED EMBODIMENTS

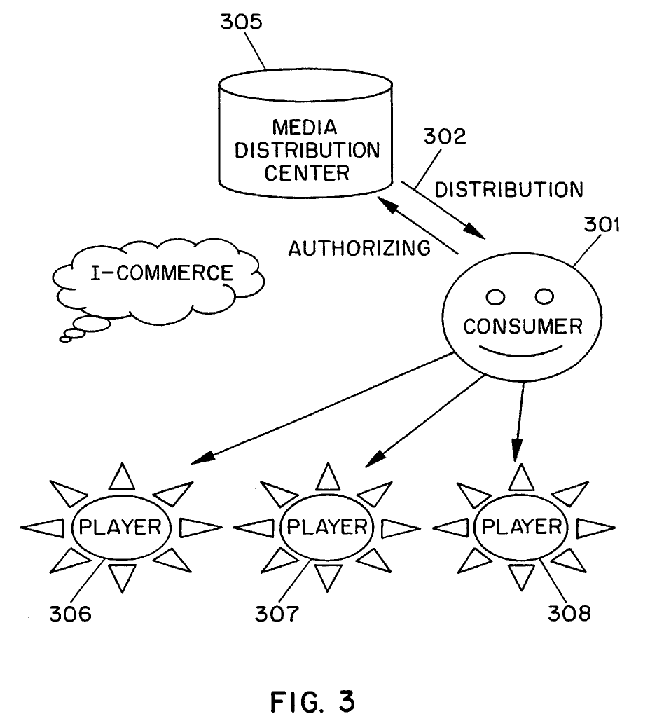

Referring to FIG. 2, one exemplary application of the techniques provided by the present invention is illustrated. An authorized user 201 can login into a multimedia service center 203, read and print secure original multimedia content 205 related to its business, and later present the printed multimedia content 205 for a business purpose or otherwise. An authorized authenticator 207 can also login into the server 203 to verify the legitimacy of received multimedia content, and check whether the received content has been altered. In circumstances where an authenticator receives a copy of original multimedia content, distortions may be present that have been introduced during a formation of a secure original multimedia content or its transmission. Some examples of such distortions are scaling, color or intensity changes, slight rotation, or distortions caused by addition of noise. These types of distortions are acceptable in the verification technique provided by the present invention.

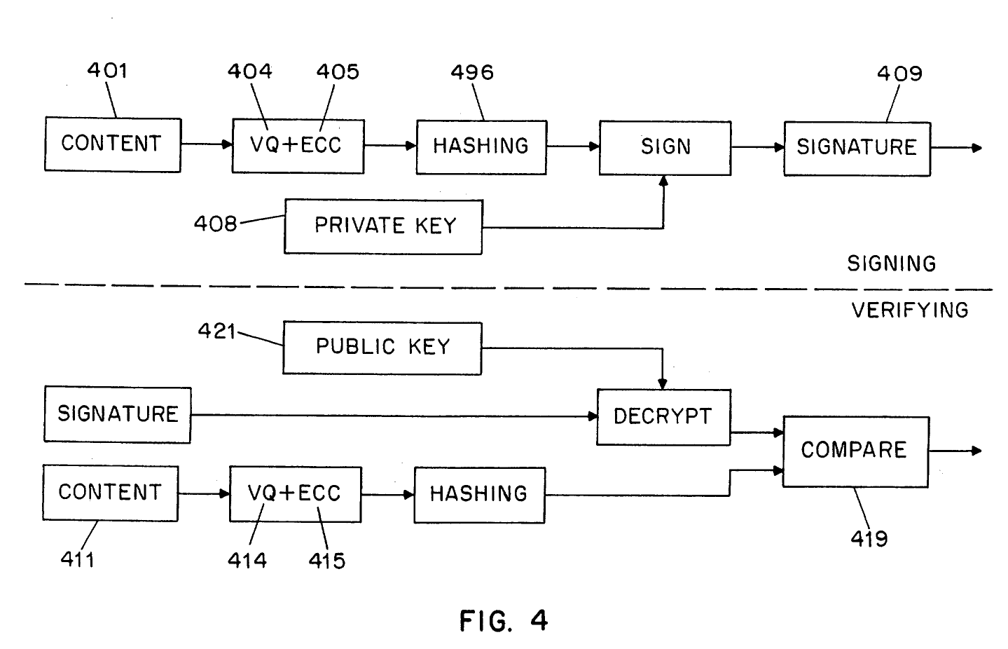

Referring next to FIG. 3, an alternative exemplary application of the techniques provided by the present invention is illustrated. FIG. 3 shows a multimedia commerce transaction where a customer 301 purchases a type of multimedia content (not shown), for example music, from a media distribution center 305. After the purchase, the multimedia content is distributed 302 to the customer 301. Assuming that the customer 301 has some reasonable rights to modify the bought music, such as to convert between audio formats of different players (MP3 (306), TwinVQ (307), or WAV (308) player), the consumer will necessarily need to convert from one format to another. The content-based signature scheme in accordance with the present invention is able to satisfy the needs of the customer while ensuring robust and flexible verification by the content owner.

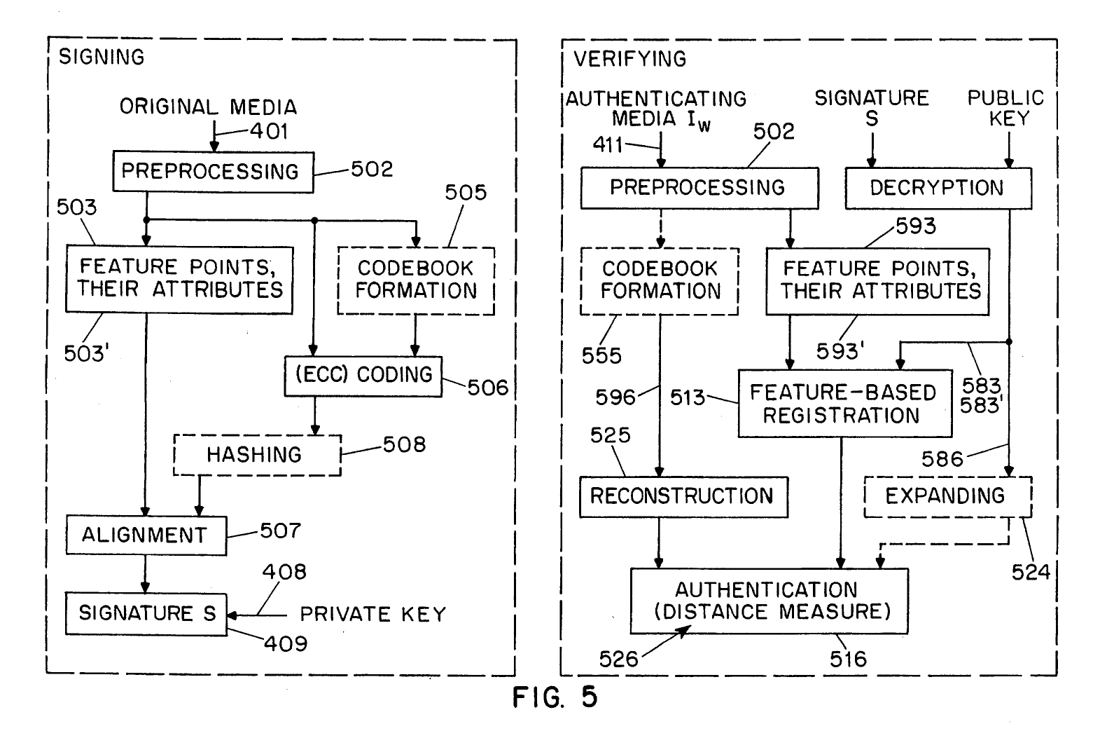

Referring to FIG. 4, a first embodiment of the present invention is now described. FIG. 4 depicts a content based signature scheme which has two parts—a process of forming an original multimedia content signature and a process of verifying received multimedia content.

During a process of forming an original multimedia signature, the first step is to detect certain invariant features (not shown) from an original multimedia content Iₒ (401), that are robust to various modifications such as adding noise, scaling, and rotating. Some examples of invariant features relating to images are corner points, average values of blocks and histograms, whereas some examples of invariant features relating to video are color values of microblocks and histograms.

The next step is to quantize original multimedia content. Quantizing of original multimedia content (404) may be implemented by dividing original multimedia content into one or more source blocks, and associating the source blocks to corresponding one or more codewords (not shown) that are either pre-determined, or automatically defined during the quantization process.

As used herein, vector quantization has been extended to a more general scope to include the scalability and flexibility of multimedia content quantization. As used herein, an operation is considered to be a quantization operation as long as the operation will scale multimedia content to some particular level based on certain pre-determined sets of rules. For example, if there are four types of objects, such as a square, a triangle, ellipse and a circle, and three types of colors, red, green and blue, there may be 12 possible objects based on two criteria—their shape and their color. If one criterion is predetermined to be more important than the other, e.g. the shape is more important than the color, then these objects may be quantized in four groups, based on their shape. This allows for a flexible quantizing based on a pre-determined set of rules. Also, certain portions of original media may need a more refined quantization than the other portions. In the previous example, certain pre-determined set of rules may require a color determination for each circle, but not requiring such determination for other shapes. Therefore, a more refined quantization would be needed for the circles, and this is referred to as scalability of vector quantization.

Based on this definition, an invariant feature extraction may be treated as a quantization operation. Also, for image files, the quantization operation can be done on different elements associated with the same block. For example, if one less important element is color and there are 256 choices of color available, the number of colors can be scaled, namely, quantized to a lesser number, for example, 16. Another example of the quantization operation would be a scaling of a video file from original to a set of shots and cuts, or even to certain representative frames.

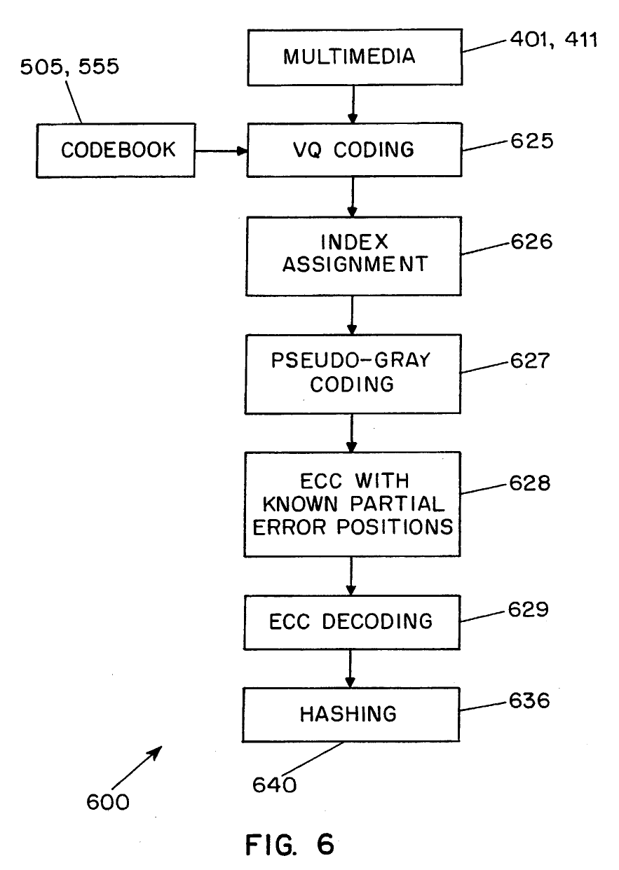

Subsequently, a digital signature 409 is formed by using a private key 408 to encrypt the extracted invariant features 503 (see FIG. 5) and quantized original multimedia content (not shown).

During a process of verifying received multimedia content, an authorized authenticator gets a digital signature 409 and received multimedia content 411. Received multimedia content 411 is quantized 414 and processed to obtain the extracted invariant features (not shown). Simultaneously, the digital signature 409 is decrypted by using a public key 421, and the extracted invariant features 583 and their attributes 583′ of original multimedia content 401 decrypted from the received digital signature 409 are compared to the extracted invariant features 593 and their attributes 593′ of received multimedia content 411. The result of comparison 419 is then evaluated.

In a preferred embodiment, the codewords 506 (see FIG. 5) representing original multimedia content are selected from a codebook 505 (see FIG. 5). The codebook is either pre-determined, in which case it is referred to as a universal codebook or an off-line codebook, or it is automatically formed during the process of quantization, in which case it is referred to as an on-line codebook. The universal codebook is transmitted with the digital signature and it is used in the verification process of received multimedia content. The on-line codebook is separately, and automatically, created on the verification side.

An error control coding scheme and hashing may be used in cases where multimedia content is large. The error control coding (“ECC”) scheme helps re-organize the codebook so that a Hamming distance between adjacent codewords equals 1. It is also preferable to assign pseudo-gray index codes to the re-organized codewords. Finally, it decodes the pseudo-gray index codes based on a pre-determined threshold and produces a result which is then hashed.

The processes of signing and verification have certain common procedures such as invariant feature extraction, vector quantization, (optional) alignment, (optional) error control coding, and (optional) hashing. The verification process also has certain unique procedures such as content registration and refined authentication. Each of these procedures are discussed in more detail below.

Invariant Feature Extraction

The first step in either the process of signing, or that of verification, of a multimedia content is a step of extracting invariant features. Referring to FIG. 5, the flowcharts of the signing and the verification processes are depicted. Original (401) and received (411) multimedia contents are initially pre-processed (502) to ensure better consistency of the results. The typical pre-processing could be low-pass filtering, intensity normalization, etc. The invariant features 503 (or 593) are extracted from pre-processed original (or received) multimedia content by using one or more detection methods. Different detection methods work well with different classes of multimedia content and different kinds of modifications, so it is preferred to use several detection methods in this step. One example of a detection method that may be used is disclosed in C. G. Harris et al., A combined corner and edge detector, 4^{th} Alvey Vision Conference, pp. 147-151 (1988) the contents of which are incorporated by reference herein. Another example of a detection method is disclosed in C. Xu, J. Wu, and Q. Sun, Audio Registration and Its Application in Digital Watermarking, SPIE EI'00, pp.393-403, San Jose (2000), the contents of which are incorporated herein. The invariant feature extraction process (not shown) can be expressed as the following:

K=∩D(Iₒ) (1)

where K=(k₁, k₂, . . . , k_{P}) is a set of invariant features 503; D=(d₁, d₂, . . . , d_{D}) is a set of detection methods (not shown) that are selected to detect the invariant features 503. These methods work independently and each detection method detects a set of features. The resulting D sets of feature sets K are, then, intersected to determine the invariant features 503. The symbol ∩ means an intersection of all sets of detected features to guarantee a consistent detection result. Once the invariant features 503 are selected, their invariant attributes 503′ are computed in a small area around the invariant features 503. For example, if an invariant feature is a corner point of an image, then the attributes such as a position of the corner, an angle of the corner, a magnitude of the corner and a moment are computed in a neighborhood of that corner. The invariant attributes of the can be expressed as follows:

A={Aₖ_{₁}, Aₖ_{₂}, . . . , Aₖ_{ₚ}, (2)

where Aₖ_{ᵢ} is a set of invariant attributes 503′ associated with the invariant feature kᵢ 503.

Aₖ_{ᵢ}={aₖ_{ᵢ}₁, aₖ_{ᵢ}₂, . . . , aₖ_{ᵢ}_{F}. (3)

In some applications, the extraction of invariant features 503′ can be implemented through the manual insertion of landmarks into the content and later extracting the landmarks from the content. For example, a printed document may not contain invariant features that can be detected by the detection methods. In such cases, certain landmarks, which are subsequently detected as invariant features, may be manually inserted. In summary, the initial signature generation or verification step requires the detection of invariant features 503 of original (or received) multimedia content 401 (or 411), and the computation of corresponding attributes 503′.

Vector Quantization

As shown in FIG. 5, the next step in either the process of signing, or that of verification, is to quantize a multimedia content. Vector quantization (“VQ”) is a process in which original multimedia content is broken into small blocks referred to as source blocks, which are then sequentially encoded block by block. Further details about VQ may be found in A. Gersho et al., Quantization and Signal Compression, Boston, Mass.: Kluwer (1992), the contents of which are incorporated by reference herein. The vector quantization encoder pairs up each source vector with the closest matching codeword, thus “quantizing” it. The actual encoding is then a simple process of sequentially mapping a source vector to a codeword from a codebook.

First, original multimedia content 401 is partitioned into small blocks (not shown). For example, in the case of audio, a small block may be referred to as an audio sample. The portioning can be defined as:

Iₒ=[x₁ x₂ . . . xₙ] (4)

where, xⱼ=[bⱼ₁, bⱼ₂, . . . , bⱼᵣ], r=1,2, . . . , B, denotes a small block j and B is the maximum size of an individual block. Each block has r elements, and all blocks have the same size, i.e., the same number of elements. It may be assumed that C represents either the universal, or the on-line codebook 505 of the size K,

C=[y(i): i=1, . . . , K] (5)

having K codewords y(i).

Each source vector xⱼ (not shown) is approximated by y(i) (not shown), which is the closest codeword to xⱼ, i.e.,

d(xⱼ, y(i))≦d(xⱼ, y(l)), (6)

for all l=1, . . . , K. Encoding of xⱼ (not shown) can simply mean mapping xⱼ to an index (not shown) of its codeword, namely

wₓ_{ⱼ}=i (7)

For all original blocks, each quantized codeword is, then, recorded and aligned to its corresponding indexing number (not shown):

w=[w₁, w₂, . . . , wₙ] (8)

If necessary, all indexing numbers may be hashed to form a VQ information (not shown):

W=H(w) (9).

One feature of the vector quantization technique provided herein is scalability. This verification technique allows for breaking original multimedia content or forming a codebook with corresponding codewords according to different levels of importance attached to different regions of original multimedia content. The quality of reconstructed multimedia content mainly depends on the size of the codebook and the size of source blocks. The larger codebook size, or the smaller source block size, yields better quality of reconstructed data. Multimedia content may be divided into several regions, where each region has a certain level of importance. Consequently, the codebook may be adjusted to provide different number of codewords corresponding to different regions based on the importance levels attributed to such regions.

Another unique feature of vector quantization is its flexible procedure in codebook formation. The maximum tolerant authentication errors can be defined on particular dimensions, particular blocks, and even on particular regions by assigning to them different thresholds. Therefore, different parts of the content can be authenticated with different levels of robustness according to the relative importance of each part.

There are at least two ways in which a codebook formation can be done. One example of a codebook formation is an off-line training, which is used to obtain a universal codebook so that both the procedure of signature formation and the procedure of signature verification can be simple and fast. Another example of the codebook formation is an on-line training, which is used to obtain a more optimal codebook so that the accuracy of authentication can be improved. The procedure of codebook formation is actually a clustering of given source blocks, as explained below.

In a given sequence of source blocks, a clustering algorithm classifies these blocks into clusters by natural association according to some similarity measure, which represents the distance between a source block and the corresponding codeword. The clustering algorithms are chosen to maximize the degree of similarity among blocks within clusters, and to minimize the degree of similarity among blocks of different clusters. In other words, the clustering algorithms try to maximize intra-cluster distances and minimize inter-cluster distances. Further details about clustering algorithms called LBG algorithms may be found in Y. Linde, et al., An algorithm for vector quantizer design, IEEE Trans. Commun. Vol.CON-28, No. 1, pp.84-95 (1980), the contents of which are incorporated by reference herein. The main elements of the clustering algorithm are choosing K initial cluster centers z₁, z₂, . . . , z_{K}, distributing the blocks among the K clusters using a minimum distance criterion, determining a centroid of each cluster of blocks and naming it a new cluster center, and comparing the new cluster centers with the previous ones. If the change is below a pre-set threshold, the algorithm is terminated; otherwise, steps 2-4 of the algorithm are repeated.

After the invariant features A 503 are extracted, their attributes 503′ computed, and the VQ codewords W 506 obtained, the final message may be made by combining all of them in the process referred to as alignment 507.

M=A∪W (10).

The final message M is then, encrypted by using the private key d 408.

In summary, a signature S 409 can be formed by using the private key 408 to sign the message M, which is a result of alignment 507 and represents the invariant features A 503 and their attributes 503′ combined with the VQ information W 506:

S=(M)^{d} (11)

The formed signature can either be put into the header of the multimedia file or stored in a verification center. The signature consists of four parts. The first part includes global information concerning original multimedia content. For example, global information for an audio signal may include the total number of samples, the number of channels, sampling rate, a bit number of each sample, the length of quantizer, and the size of the codebook. Global information for an image may be the original image size, block size, codebook size, or the number of bits for each pixel. Global information for a video signal may include the total number of frames, the size of a frame, the codebook size, or the size of a quantization vector.

The second part of the signature represents the invariant features that are extracted from original multimedia content. It is mainly used for feature-based registration of received multimedia content with respect to original multimedia content by comparing and matching the invariant features decrypted from the signature with those extracted from received multimedia content.

The third part represents VQ codewords or corresponding index codes which can be used to authenticate received multimedia content, and can be either hashed or non-hashed. Non-hashed codewords or index codes can be used to indicate positions of modified parts in received multimedia content. Hashed codewords may be used to determine that received multimedia content has been modified, but they cannot be used to localize the positions of modified parts.

The fourth part contains control information such as distance threshold which is used to define a range of allowable distortions of received multimedia content.

The signature size may vary with an accuracy level of the verification procedures. For example, for a grey-scale (8 bit for pixel) image with a size of 256*256 pixels, if the codebook size is 256 and the block size is 8*8 pixels, the size of the first part of the signature will be around thirty-six bits. As an example, if ten invariant features are used in the second part, each point requires 50 bits to describe its feature values; thus the size of the second part is 500 bits. The third part is very clear: 128 bits are needed for the hashed VQ codewords and 8192 bits for the non-hashed VQ codewords. The size of the fourth part is around 10 bits. Therefore, the total size of a signature is: 36+500+128+10=674 bits for a signature with hashed VQ codewords and 36+500+8192+10=8738 bits for the signature with non-hashed codewords.

The resulting signature sizes are comparable to those obtained by traditional cryptography, which are usually between 1024 and 8192 bits. There are many solutions to further reduce the signature size by reducing the signature part representing the non-hashed VQ codewords. Some examples include entropy coding, re-quantizing the non-hashed codewords, coding of only the difference signs (or changes) of adjacent VQ codewords, transform VQ, and predictive VQ.

After an authorized authenticator receives multimedia content 411 and its associated signature 409, it can determine the legitimacy of received content 411 by verifying the correctness of the signature 409 using a public key 421. When original multimedia content has been slightly modified, e.g. scaled, it may be hard to locate the position from which the authentication should start. This is one of the reasons why previous verification methods could not authenticate scaled contents. The present invention uses a content registration procedure 800 which allows a certain level of distortions of received multimedia content as explained below.

Content Registration

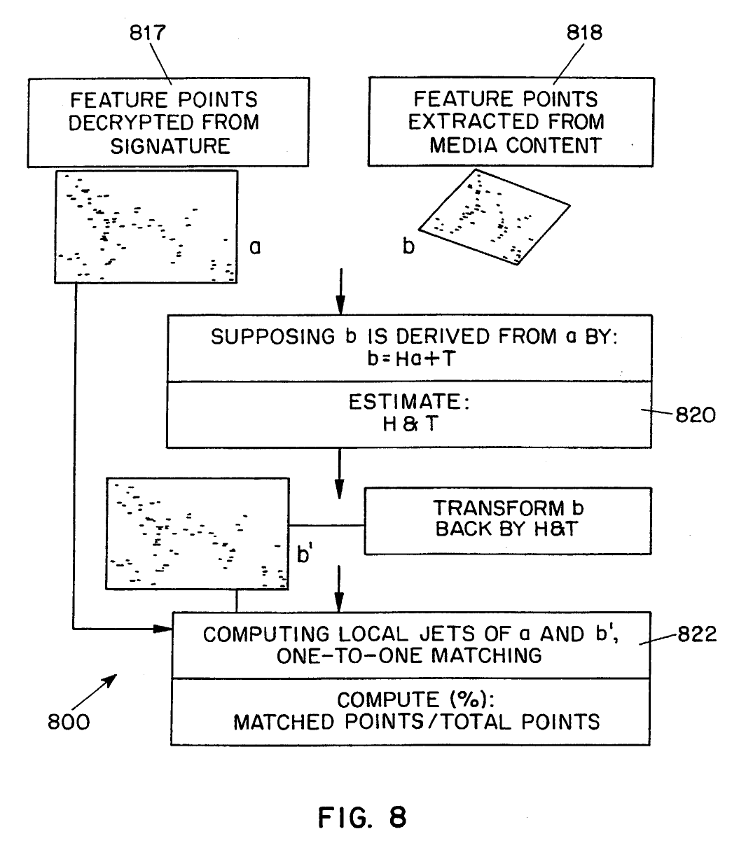

Referring to FIG. 8, an exemplary a content registration procedure 800 is shown. Here, the invariant features 503 and 593 are used to register received multimedia content 411, since this procedure does not significantly increase the size of the signature. In the verification procedure, a comparison (not shown) and a matching procedure (not shown) are first done between the features decrypted 583 from the signature 409 and the features extracted 593 from the received media 411. This procedure, referred to as a feature-based registration 513, is particularly useful where authenticating scanned content. The registration information (not shown) can be included in the signature 409 with a private key 408.

Similar to the procedure of signature generation, a set of invariant features 593 is extracted from I_{w} 411 using the same feature detection algorithms as in signature generation (1). Furthermore, the attributes 593′ associated with the extracted invariant features are computed.

K′=∩D(I_{w}) (12)

Simultaneously, another set of invariant features 583 and their associated attributes 583′ are decrypted from the signature 409 by using the public key e421.

K″=S^{e} (13)

In some cases, the correlation is perfect, namely, K′=K″. In other cases, the K′ and K″ may not be the same, but there still may be some matching relationship between K′ and K″. This matching relationship may be estimated (820) by comparing the invariant features of decrypted digital signature and received multimedia content, and determining whether received content has been slightly or significantly distorted based on a pre-defined distance threshold. If the distance between the corresponding features falls within the threshold, it means that the received content is still legitimate. Otherwise, the authentication fails.

Attributes 593′ of the extracted invariant features 593 preferably include their positions, magnitude, moments, and other attributes computed in the neighborhood of the invariant features, such as slope and central frequency for audio, or the differential Gaussian filtering for image. The invariant features extraction is a relative measure and has limitations. For example, the extracted attributes 503 and 593 for images remain invariant only within a scaling range from −15% to 15% of the original size.

The content registration procedure has a hierarchical structure. The first step is a rough estimation of possible transformations of received multimedia content (820). Also, two sets of invariant features representing original (817) and received (818) multimedia contents are compared to estimate any modifications. The modifications are estimated by computing the matrix of moments derived from the coordinates of invariant features. Further details may be found in Q. B. Sun, et al., Recovering modified watermarked image with reference to original image, SPIE 3697, EI99, San Jose (1999), the contents of which are incorporated by reference herein. After this rough estimation, insensitive invariant attributes are computed and associated with the invariant features.

The second step is a refined matching of the invariant attributes to obtain one-to-one point correspondence 822. It is important to note that all invariant attributes are in the same domain. The one-to-one matching 822 is done by directly looking for the best-matching point in another set based on a pre-defined threshold.

The third step is a spatial registration used to determine whether a received content must be slightly adjusted, such as scaled or rotated or shifted to adjust the extracted invariant features of received multimedia content with respect to the decrypted invariant features.

The fourth step registers the changes of magnitude, if there are any, to modify the intensity of the extracted invariant features of received multimedia content with respect to the decrypted invariant features. The registration is finalized by solving surface spline functions among all matched point-pairs (solving n+3 linear equations if the number of matched pairs is n).

In an alternative embodiment, the rough authentication result can be given as a percentage representing the total number of matched features.

The next step in the verification process is a refined authentication 516.

Refined Authentication Process

If the received message 411 is not modified, the result of the refined authentication process 516 is “true.” This is similar to the procedure of traditional verification. However, if the received message has been changed, the refined authentication result of the present invention yields a distance measure 526. It is up to a particular application to determine, by selecting a proper threshold T, whether received multimedia content 411 has been altered, and to detect which parts of media have been modified.

After content registration 800, the consistence between the VQ codewords 596 quantized from the received media 411 and the set of codewords 586 decrypted from the signature 409 is verified. Here, the vector quantization of received media 411 is conducted in one of two ways based on the results from the feature-based authentication 513. If the modifications are not severe, the codebook 555 can be generated on the verification side, if an on-line codebook is used. The codebook must remain the same on both the signing and the verification sides to ensure that a consistent and a reliable authentication is obtained. The codewords 506 can be hashed 508 and put into the signature 409 to verify the consistency between the codebooks 505 and 555 on both sides. While this may impose a slight burden on the system, such burden is not significant. For example, a codebook with 256 codewords and 16 bytes per codeword needs only 4 Kbyte, which can be transmitted within seconds. Under the digital signature scheme, communication with a Trusted Third Party (“TTP”) in transferring digital signature 409, public key 421, and login information is necessary. When compared to the size of multimedia that is transferred, the size of the codebook 505 will not impose much burden on the system. Also, a universal codebook may be used. In such cases, the codebook is transmitted in advance.

Finally, the refined authentication can be conducted in two ways: if the VQ codes were not hashed, received multimedia content 411 can be re-constructed 525 according to the codewords decrypted 586, de-compressed 524 and decoded from the signature 409 and the codebook 555. The error distance measure 526 between the reconstructed media 525 and the received media 411 is then computed directly. In this case, the modified part of received multimedia content 411 can be localized.

If the VQ codewords were hashed 508, quantized codewords 596 representing received multimedia content 411 based on the codebook 555 are obtained, hashed and compared to the hashed codewords 586 decrypted from the signature 409 bit by bit. In this case, it only can be indicated whether multimedia content has been altered; the location of change cannot be found.

An optional step of hashing 496 represents a processing of the VQ codewords in a signature to yield a hashing result that uniquely represents original multimedia content. Even the slightest distortion of it produces different hashing results. This is why hashing is done in conjunction with an error control code scheme, which ensures that slightly distorted multimedia content still yields the same hashing result.

Error Control Coding

In cases where a size of a multimedia signature is a concern, an alternative embodiment having an error control codes (“ECC”) procedure of forming the multimedia signature 405 may be used. The ECC procedure requires re-organizing of codewords and assigning of pseudo-gray code labels to re-organized codewords, so that the Hamming distance between adjacent pseudo-gray codes equals 1. In case of an acceptable modification of original multimedia content, the VQ codewords of received multimedia content, then, may not equal the VQ codewords of original multimedia content, but their pesudo-gray code labels will still be within the Hamming distance. This means that the codewords, representing the acceptably distorted parts of received multimedia content will be located very close to the codewords representing source blocks of original multimedia content. This would allow for a possible error location during a process of authentication.

Distortion caused by some modifications such as adding white noise, printing or rescanning, yield a distance measure between the invariant features and the corresponding codewords that is small. In contrast, distortions caused by malicious manipulations, such as copy-paste, forgery, yields distance measures between the invariant features and the corresponding codewords that are usually large. Based on this observation, an error control coding (ECC) procedure may be used to distinguish acceptable from malicious manipulations.

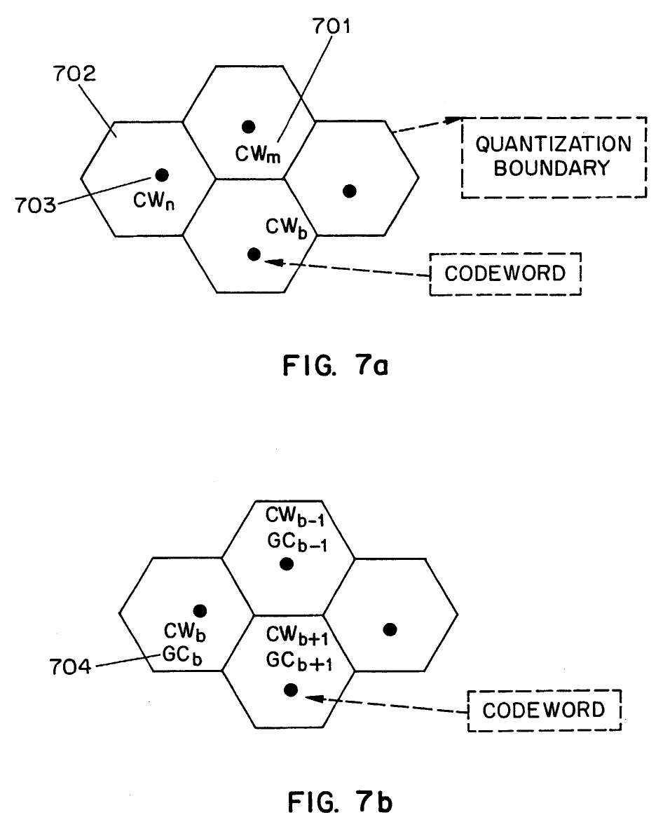

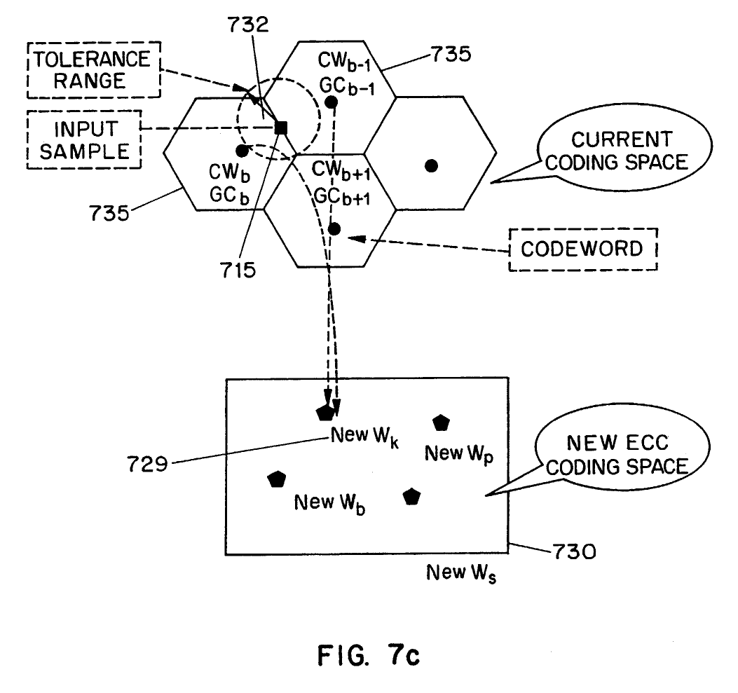

Referring to FIG. 6, an alternative verification technique which incorporates an error control code procedure 600 is illustrated. As shown in FIG. 6, original multimedia content 401 (or received multimedia content 411) is vector quantized to obtain a set of codewords 625. The codewords are then re-organized in the index assignment 626 (see FIG. 7(a)) so that the distance between adjacent codewords is minimized. After the codebook re-organization, pseudo-gray code labeling 627 of the re-organized codebook is obtained. Subsequently, the resulting codes are ECC decoded 629, and finally hashed 636 to obtain a secure hashed code 640 that is insensitive to acceptable distortions of received multimedia content.

Referring to FIG. 7(a), a set of codewords after VQ Coding 625 is illustrated. The indexes 701 of the adjacent codewords 702 are disordered, namely, they are CWₙ, CW_{b}, and CWₘ. The centers of codewords 703 are illustrated. During the process of index assignment 626, the whole codebook 505 (or 555) is re-organized under the criterion that a minimum distance between adjacent codewords is minimized. The re-organization can be implemented by optimization algorithms. For example, the binary switch algorithms introduced by the Zeger reference or by P. Knagenhjelm, Hadamard Transform—a Tool for Index Assignment, IEEE Trans. IT, Vol. 42, No. 4, pp. 1139-1151, the contents of which are incorporated by reference herein.

Referring now to FIG. 7(b), a diagram representing a set of codewords 702 after re-organization 626 is illustrated. The indexes 701 of the adjacent codewords are in the following order: CW_{b-1}, CW_{b}, and CW_{b+1}. Also, the indexes are re-coded 704 to obtain pseudo-gray code labels 627: GC_{b-1}, GC_{b}, and GC_{b+1}. A property of pseudo-gray code is that the Hamming distance between adjacent code labels representing adjacent codewords is only 1. Therefore, even if a distorted block of received multimedia content is assigned to a different codeword from the corresponding source block of original multimedia content, since the distance between those two codewords is very small, they will be close to each other.

Therefore, supposing that there are some minor distortions, the received index code labels representing the codewords of received multimedia content will not match the corresponding original index code labels 701 representing the codewords of original multimedia content. Nevertheless, the received index code labels will be located close to the original index code labels 701. In other words, the hamming distance between the received index code labels and the original index code labels 701 is 1. For example, the original index code label 701 may be 11100111, the new index code label may be 11101111. The positions of the resulting pseudo-gray codes can be classified into perfect positions and possible error positions. A perfect position means that a digit is at the correct position. A possible error position means that the digit may be at the wrong position and that it should be evaluated. The index code label is then ECC encoded and decoded by using an ECC decoding scheme 629. The detailed ECC encoding technique can be found in L. A. Bassalygo, et al., Coding for Partially Localized Errors which is incorporated by reference herein.

Referring to FIG. 7(c), an ECC decoded set 629 of codewords 702 is illustrated. The source block is shown as black square 715, and the pre-determined authentication threshold is depicted by a radius of a circle 732. The codewords 735 inside the circle will be taken into account for ECC. After ECC encoding 628 and decoding 629, the codewords that are within a pre-specified threshold are mapped onto a new code NewWₖ 729 shown in a new ECC coding space 730. The ECC decoded set 629 of codewords is insensitive to accepted modifications, such as scaling etc. Therefore, a hashed code 636, insensitive to acceptable modifications, can be obtained.

With respect to malicious manipulations, the received index code labels will not be located in the threshold circle of the corresponding original index code labels, so a different mapping onto a new code NewWₖ 729 will result. A different new code, which is a result of ECC decoding is hashed, and a different hashing result 636 is produced. Therefore, acceptable modifications may be distinguished from malicious manipulations.

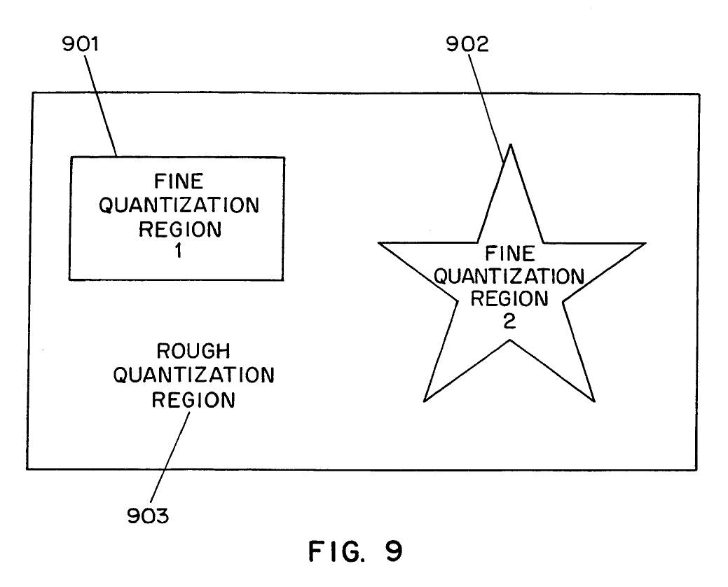

Referring to FIG. 9, an example of multimedia content having regions with different levels of importance is illustrated. If multimedia content is an image, the VQ codebook 505 can be changed so that the important image regions within the image have stronger protection. For example, regions 901 and 902, which may correspond to a face and hands, are more important than a region 903. Hence, more codewords 506 can be assigned to source vector blocks corresponding to the important regions 901 and 902, while less codewords 506 can be assigned to vector blocks corresponding to less important region 903.

Simultaneously, the maximum error on dimensions as well as a maximum block average error in the procedure of forming the codebook 505 is limited. The maximum error on dimensions represents the maximum of errors on dimensions with respect to each element of the original and the received block. A maximum average block error is an average value of errors for each element.

The unequal protection technique may be important for application files such as MPEG-4 that have different security requirements associated with different regions. For example, National Map Authorities publishes architectural design maps. The maps have many layers of plots representing, for example, plumbing, or electrical wiring. Such layers are very important and must not be altered, whereas other layers representing interior or exterior design are not as important and some modification is allowed. As a result, different levels of importance are attached to different layers, and they are coded differently, thus allowing for greater protection of layers such as plumbing or electrical wiring.

Also, the unequal protection technique may be used in optical character recognition (“OCR”) applications where it is necessary to distinguish between similar alphanumeric symbols. For example, the letter “l” and the number “1” in Roman Fonts may have the same codeword. By using the unequal protection procedure, similar letters may be assigned to one codeword to obtain a consistent verification result. Alternatively, the similar letters may be distinguished by increasing the resolution of files to be authenticated. If in some applications the security is a primary concern, these ambiguous patterns may further be distinguished either by increasing the resolution of these special parts or by adding some special codewords to take care of these special cases.

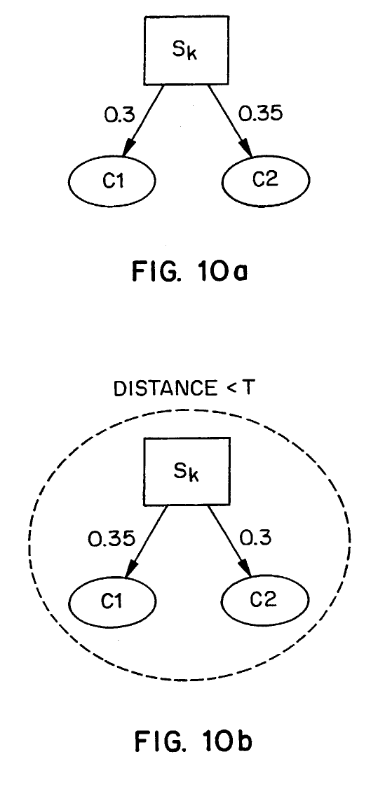

Referring to FIGS. 10(a) and (b), a codeword switching solution is illustrated. FIGS. 10(a) and (b) depict exemplary multimedia content which is partitioned into small blocks of pre-determined size, one of which is a source block Sₖ 1001 before it is signed. A codebook (not shown), having the codewords C1 1002 and C2 1003, is also pre-determined. In certain cases, the distance between the codeword C₁ 1002 and the codeword C₂ 1003 may be regarded as small under a pre-determined codebook and block sizes. In cases where a distance between C1 1002 and C2 1003 is small, a source block Sₖ 1001, which is located slightly closer to C₁ (1002) than to C₂ (1003), is assigned to the codeword C₁ (1002).

Subsequently, when the source block Sₖ 1001 is authenticated, the distances from Sₖ 1001 to C₁ and C₂ may slightly change due to certain distortions in the transmission procedure. Referring to FIG. 10(b), the source block Sₖ 1001 is now assigned to C₂ 1003, and a wrong authentication result is produced. This issue is addressed by setting a particular threshold, dependent upon a particular codebook format and a particular codeword formation scheme. If there are p codewords (not shown) whose distances to Sₖ are below a threshold T, these p codewords are treated as virtually equivalent with respect to Sₖ.

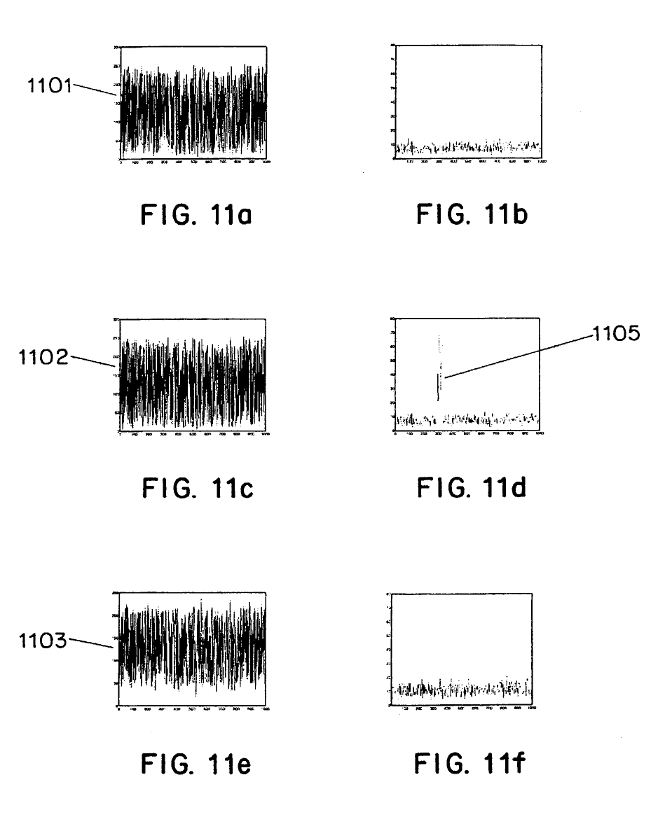

Referring to FIGS. 11(a-f), sample verification results of an original (1101), forged (1102) and time-compressed (1103) audio signals are provided. The audio signals are authenticated using the previously discussed procedures, and the forged part 1105 is detected (See FIG. 11(d)).

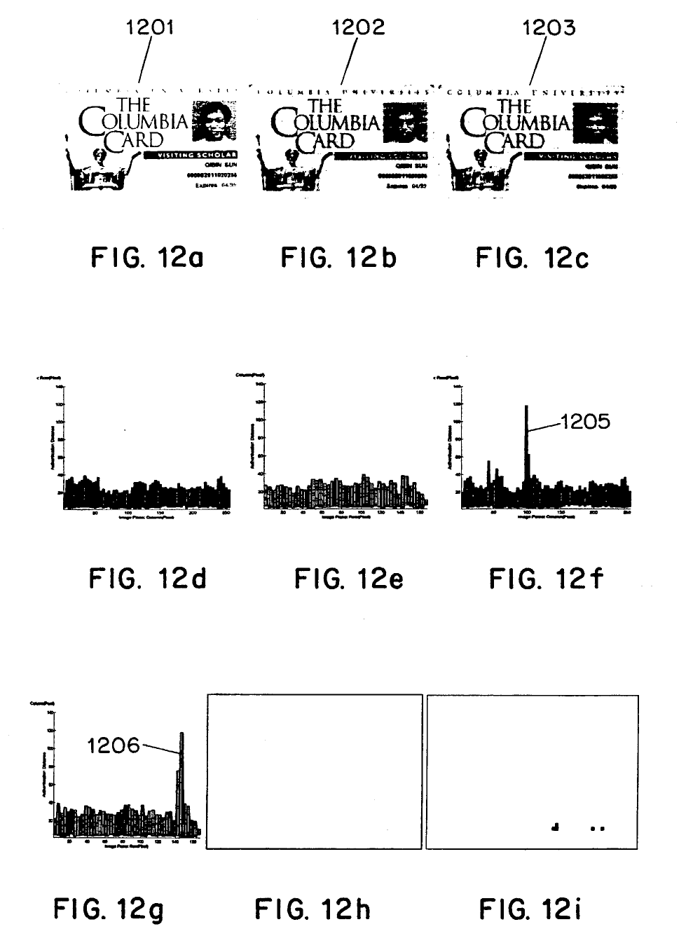

Another example of the verification results is shown in FIGS. 12(a-h). FIGS. 12(a-c) depict an original (1201), a printed original (1202), and a forged (1203) ID cards. The printed original image 1202, and the forged image 1203 are authenticated using the previously discussed procedures, and the two forged parts 1205 and 1206 have been detected. (See FIGS. 12(f), (g), and (h)).

The foregoing merely illustrates the principles of the invention. Various modifications and alterations to the described embodiments will be apparent to those skilled in the art in view of the teachings herein. It will thus be appreciated that those skilled in the art will be able to devise numerous techniques which, although not explicitly shown or described herein, embody the principles of the invention and are thus within the spirit and scope of the invention.

1. A method for generating a digital signature representing the source of associated multimedia content, comprising the steps of.
(a) extracting one or more invariant features from said multimedia content,
(b) quantizing said multimedia content,
(c) selecting a private key for encrypting said quantized multimedia content and said one or more extracted invariant features, and
(d) encrypting said quantized multimedia content and said one or more invariant features by using said private key to form a digital signature.

2. The method of claim 1, wherein said multimedia content is selected from the group consisting of an image, an audio signal, and a video signal.

3. The method of claim 1, further comprising the step of pre-processing said multimedia content prior to step (a) to ensure better consistency of results.

4. The method of claim 1, wherein said step of extracting one or more invariant features further comprises applying one or more feature detection algorithms to detect said invariant features.

5. The method of claim 4, wherein one of said one or more detection algorithms comprises a corner and edge detector algorithm.

6. The method of claim 1, wherein said step of extracting one or more invariant features further comprises computing one or more invariant attributes corresponding to said one or more invariant features.

7. The method of claim 1, wherein said step of extracting one or more invariant features further comprises manually inserting one or more landmarks into said multimedia content.

8. The method of claim 1, wherein said quantizing step further comprises dividing said multimedia content into one or more source blocks.

9. The method of claim 8, wherein said multimedia content comprises one or more regions having one or more levels of predetermined importance, such that each of said one or more regions corresponds to one or more of said source blocks.

10. The method of claim 9, further comprising the step of assigning one or more codewords to each of said one or more source blocks.

11. The method of claim 10, wherein said one or more codewords are selected from a codebook.

12. The method of claim 11, wherein each of said one or more codewords are hashed.

13. The method of claim 11, wherein said codebook is selected from the group consisting of a universal codebook and an on-line codebook.

14. The method of claim 13, wherein said codebook is formed by a clustering of said source blocks.

15. The method of claim 14, wherein said clustering comprises a centroid clustering.

16. The method of claim 1, wherein said digital signature further comprises global information selected from the group consisting of global information concerning the protected media, the registration information, quantized codes or an authentication threshold.

17. The method of claim 11, further comprising the step of mapping one or more codewords that are within a predetermined threshold onto a new index code in an error control coding procedure

18. The method of claim 17, wherein said new index code is hashed.

19. A method for verifying multimedia content having an associated digitized multimedia signature, comprising:
(a) extracting one or more invariant features from said multimedia content;
(b) quantizing said multimedia content;
(c) decrypting said multimedia signature by using a public key; and
(d) verifying said received multimedia content.

20. The method of claim 19, wherein said multimedia content is selected from the group consisting an image, an audio signal, and a video signal.

21. The method of claim 19, further comprising the step of pre-processing said multimedia content prior to step (a).

22. The method of claim 19, wherein said step of extracting one or more invariant features further comprises applying one or more feature detection algorithms to detect said invariant features.

23. The method of claim 19, wherein said step of extracting one or more invariant features further comprises computing one or more invariant attributes corresponding to said one or more invariant features.

24. The method of claim 19, wherein said quantizing step further comprises said multimedia content into one or more source blocks.

25. The method of claim 24, wherein said multimedia content comprises one or more regions having one or more levels of predetermined importance, such that each of said one or more regions corresponds to one or more of said source blocks.

26. The method of claim 25, further comprising the step of assigning one or more codewords to each of said one or more source blocks.

27. The method of claim 26, wherein said one or more codewords are selected from a codebook.

28. The method of claim 27, further comprising the step of mapping one or more codewords that are within a pre-determined threshold onto a new index code in an error control coding procedure.

29. The method of claim 28, wherein said new index code is hashed to increase security and reduce its size.

30. The method of claim 19, wherein said step of verifying said received multimedia content comprises the steps of comparing of one or more invariant features decrypted from said multimedia signature with said one or more invariant features extracted from said multimedia content to determine a correlation therebetween.

31. The method of claim 30, wherein said determined correlation is determined based on a predetermined threshold.

32. The method of claim 31, wherein said step of verifying said multimedia content further comprises the step of conducting a refined authentication procedure to said decrypted multimedia signature and said quantized multimedia content.

33. The method of claim 21, wherein said refined authentication procedure comprises localizing one or more modified parts of non-hashed multimedia content.

34. A method for verifying a portion of multimedia content having an associated digitized multimedia signature, comprising:
(a) extracting one or more invariant features from said portion of multimedia content;
(b) quantizing said multimedia content portion;
(c) decrypting said multimedia signature by using a public key; and
(d) verifying said received portion of multimedia content.

35. The method of claim 34, wherein said multimedia content portion is selected from the group consisting an image, an audio signal, and a video signal.

36. The method of claim 34, further comprising the step of pre-processing said multimedia content portion prior to step (a).

37. The method of claim 34, wherein said step of extracting one or more invariant features further comprises applying one or more feature detection algorithms to detect said invariant features.

38. The method of claim 34, wherein said step of extracting one or more invariant features further comprises computing one or more invariant attributes corresponding to said one or more invariant features.

39. The method of claim 34, wherein said quantizing step further comprises dividing said multimedia content portion into one or more source blocks.

40. The method of claim 39, wherein said multimedia content portion comprises one or more regions having one or more levels of predetermined importance, such that each of said one or more regions correspond to one or more of said blocks.

41. The method of claim 40, further comprising the steps of assigning one or more codewords to each of said one or more source blocks.

42. The method of claim 41, wherein said one or more codewords are selected from a codebook.

43. The method of claim 42, further comprising the step of mapping one or more codewords that are within a pre-determined threshold onto a new index code in an error control coding procedure

44. The method of claim 43, wherein said new index code is hashed.

45. The method of claim 44, wherein said step of assigning is based on said one or more levels of predetermined importance associated with said one or more regions.

46. The method of claim 34, wherein said step of verifying said received multimedia content portion comprises the steps of comparing of one or more invariant features decrypted from said multimedia signature with said one or more invariant features extracted from said portion to determine a correlation therebetween.

47. The method of claim 46, wherein said determined correlation is determined based on a predetermined threshold.

48. The method of claim 47, wherein said step of verifying said portion of multimedia content further comprises the step of conducting a refined authentication procedure to said decrypted multimedia signature and said quantized of multimedia content portion.

49. The method of claim 34, wherein said refined authentication procedure comprises localizing one or more modified parts of non-hashed multimedia content.
